(19) United States
(12) Patent Application Publication
(10) Pub. No.: US 2024/0151428 A1
(43) Pub. Date: May 9, 2024

(54) AIR PURIFIER

(71) Applicant: HOKWANG INDUSTRIES CO., LTD., New Taipei City (TW)

(72) Inventor: Shen-Chen LIU, New Taipei (TW)

(21) Appl. No.: 17/981,856

(22) Filed: Nov. 7, 2022

(51) Int. Cl. F24F 13/20; E05B 45/06; E05B 47/00; F24F 8/22

(52) U.S. Cl. CPC F24F 13/20; E05B 45/06; E05B 47/0002; F24F 8/22; E05B 2045/0665

(57) ABSTRACT

An air purifier includes a body and a control module. The body is provided with a case, a case door arranged on the case and a door lock; the case is provided with at least one filter, at least one ultraviolet lamp and at least one controller capable of being operated; the door lock includes a magnetic reed switch and a lock matched with the magnetic reed switch; the lock is provided with a lock tongue and a magnet forming a magnetic attraction relationship with the magnetic reed switch; and the lock is provided with a first state, in which the magnet is released from the magnetic attraction relationship when the lock tongue is rotated to a specific angle, and a second state when the magnetic attraction relationship of the magnet is not destroyed.

### FIELD OF THE INVENTION

The invention relates to an air purifier, in particular to an air purifier capable of locking a state of a controller.

### BACKGROUND OF THE INVENTION

With the improvement in quality of life and the aggravation of environmental air pollution, numerous air purifier products are launched in the market currently, and currently commercially available air purifiers are mostly internally equipped with air filters, ultraviolet light sterilizer combinations and the like. When an air purifier works, polluted air enters the air purifier, dust, particulate matters, mold spores and the like in the air are intercepted by the air filter; and bacteria and viruses in the air are killed by ultraviolet light projected by the ultraviolet light sterilizer combinations at the same time, so that the air exhausted by the air purifier is purified.

However, ultraviolet light produced in the air purifier severely damages eyes of a human. In order to prevent the eyes from being exposed to the ultraviolet light by mistake, the conventional air purifier is provided with human eyes protection mechanism. In detail, once a case door of the air purifier is opened, an interlock switch on the case door blocks electricity flow of the ultraviolet light sterilizer combination, so that the ultraviolet light sterilizer combination cannot generate the ultraviolet light; and by virtue of this, personnel is protected from being exposed to the ultraviolet light, as provided in Taiwan Patent No. 442320.

Also, in the Taiwan Patent No. 442320, the ultraviolet light sterilizer combination is designed to be located on a main power supply circuit. When the case door is opened, the electricity of the ultraviolet light sterilizer combination is also cut off while a main power supply of the air purifier is turned off. However, in the Taiwan Patent No. 442320, the ultraviolet light sterilizer combination is arranged on the main power supply circuit, so that, for the air purifier to prevent the ultraviolet light sterilizer combination from continuously working when the case door is opened, it can only also block implementation of the electricity of the ultraviolet light sterilizer combination. In addition, in aspect of a circuit design in the Taiwan Patent No. 442320, an additional insulation path of the ultraviolet light sterilizer combination is needed to achieve insulation safety, which results in complex circuit design. Furthermore, the Taiwan Patent No. 442320 does not specifically describe a power-off time point of the ultraviolet light sterilizer combination, so it is possible that the ultraviolet light sterilizer combination in TW 442320 is turned off only until the case door is completely opened, which results in that a user still possibly has a risk of being exposed to the ultraviolet light by mistake when opening the case door.

### SUMMARY OF THE INVENTION

A main purpose of the invention is to solve the problem of a conventional air purifier that a user is still possibly exposed to ultraviolet light when a case door is opened.

Another purpose of the invention is to solve the problem that an additional insulation path is required because an ultraviolet light sterilizer combination is located on a main power supply circuit.

To achieve the above purposes, the invention provides an air purifier, comprising a body and a control module. The body is provided with a case, a case door arranged on the case and provided with at least one air inlet, and a door lock. The case is provided with at least one air outlet, an air blower provided with an air outlet part facing the at least one air outlet, a working chamber communicated with the at least one air inlet and an air inlet part of the air blower, at least one filter arranged in the working chamber, at least one ultraviolet lamp arranged at the working chamber, and at least one controller, the at least one controller is apparently provided on a surface of the case and generates a control signal after being operated. A state of the door lock decides whether the case door allows the working chamber to be switched open. The door lock includes a magnetic reed switch arranged at the case, and a lock matched with the magnetic reed switch. The lock is provided with a lock cylinder on the case door, a lock tongue connected with the lock cylinder and being rotated relative to the magnetic reed switch, and a magnet arranged on the lock tongue and forming a magnetic attraction with the magnetic reed switch. The lock is provided with a first state and a second state, when the lock is in the first state and the lock tongue is rotated relative to the lock cylinder to a specific angle, the magnet breaks the magnetic attraction with the magnetic reed switch, and when the lock is in the second state, the magnetic attraction between the magnet and the magnetic reed switch is not broke. The control module is provided with a power supply unit and a control unit, the power supply unit arranged at the case and connected with the air blower and the ultraviolet lamp, the control unit connected with the power supply unit. The control unit deciding works of the air blower and the ultraviolet lamp based on the control signal, the control unit being provided with a forced stop state of locking the controller to disable the controller to generate the control signal when the lock enters the first state, and the control unit being provided with a normal working state of the controller unlocked when the lock is in the second state.

In one embodiment, specific angle is 50 degrees.

In one embodiment, the door lock comprises a stopper arranged on one side of the case adjacent to the case door, and the stopper provided for the lock tongue abutting thereto.

In one embodiment, the stopper and the magnetic reed switch are located on two opposite sides of the lock tongue respectively.

In one embodiment, the case comprises a deodorizer arranged in the working chamber.

In one embodiment, the case comprises a rack and a housing, the rack is provided for the air blower to be arranged thereon, and the housing connects the rack and the case door.

In one embodiment, the case comprises an air blowing chamber communicated with the air outlet part of the air blower and the air outlet.

In one embodiment, the case is internally provided with an air blowing inner box arranged on the rack and defining the air blowing chamber.

In one embodiment, the rack and the housing collectively define a bridging chamber bridging the air inlet part of the air blower and the working chamber.

In one embodiment, the air purifier comprises an external air exhaust pipe externally connected to the case and communicated with the air outlet.

In one embodiment, the air purifier comprises an engagement sleeve sleeved on the external air exhaust pipe and engaging to the air outlet.

In one embodiment, the case comprises at least one positioning groove, the at least one positioning groove is formed in the working chamber, and the filter is arranged in the at least one positioning groove.

In one embodiment, the case comprises at least one positioning piece arranged in the working chamber, and the at least one positioning piece is shaped into the at least one positioning groove.

In one embodiment, the case comprises at least one shielding plate arranged in the working chamber and located on one side of the ultraviolet lamp adjacent to the case door.

In one embodiment, the at least one shielding plate comprises a first plate and a second plate connected with the first plate, and an included angle is formed between the first plate and the second plate.

In one embodiment, the shielding plate comprises a ridge line arranged at a joint of the first plate and the second plate, and at least one hollowed area arranged on the ridge line.

In one embodiment, the body comprises at least one convex column arranged on the case, and at least one opening formed in the case door and matched with the convex column.

Through the foregoing implementation of the invention, compared with the conventional air purifier, the invention has the following characteristics that: through designs of the door lock and the control unit, when the lock is operated and the lock tongue is rotated to the angle when opening the case door, the control unit locks the controller, so that the controller is disabled to generate the control signal after being operated. Thus, the user is prevented from being exposed to the ultraviolet lamp by mistake. In addition, the invention further reduces the risk that the user makes a contact to the controller by mistake when the case door of the air purifier is opened. Meanwhile, the magnetic reed switch of the invention does not control the power supply unit, but decides work of the control unit. Thus, an insulation path required for the magnetic attraction between the magnetic reed switch and the magnet is omitted.

### BRIEF DESCRIPTION OF THE DRAWINGS

FIG. 1 is a perspective view according to one embodiment of the invention.

FIG. 2 is an exploded perspective view (I) according to one embodiment of the invention.

FIG. 3 is an exploded perspective view (II) according to one embodiment of the invention.

FIG. 4 is a schematic diagram of an implementation architecture according to one embodiment of the invention.

FIG. 5 is a perspective view according to one embodiment of the invention.

FIG. 6 is an enlarged partial view according to one embodiment of the invention.

FIG. 7 is a schematic diagram of an implementation according to one embodiment of the invention.

FIG. 8 is a partial top view according to one embodiment of the invention.

FIG. 9 is a schematic diagram including an external air exhaust pipe according to one embodiment of the invention.

### DETAILED DESCRIPTION OF THE PREFERRED EMBODIMENTS

The detailed description and the technical content of the invention are described in cooperation with the drawings as follows now:

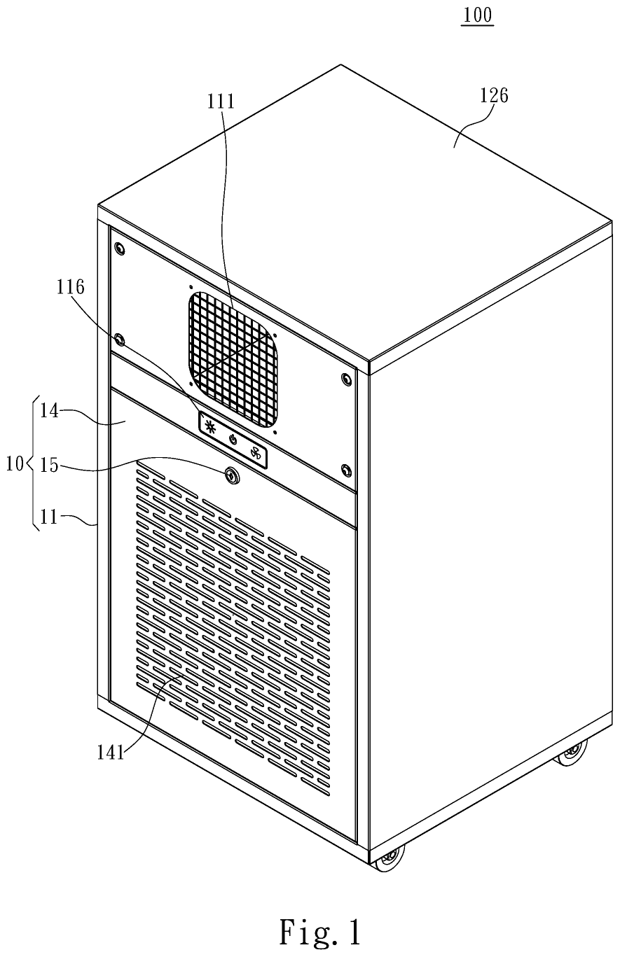

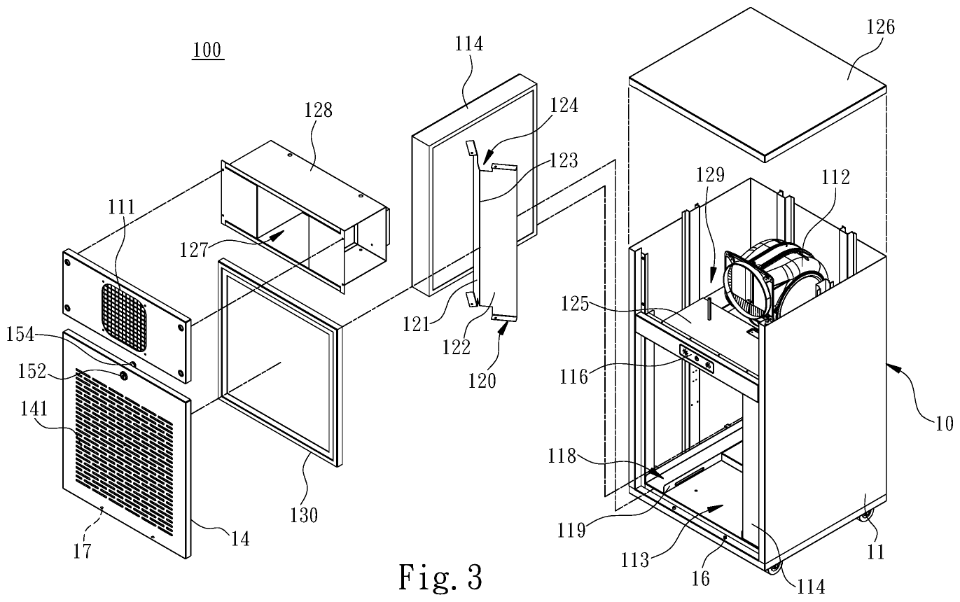

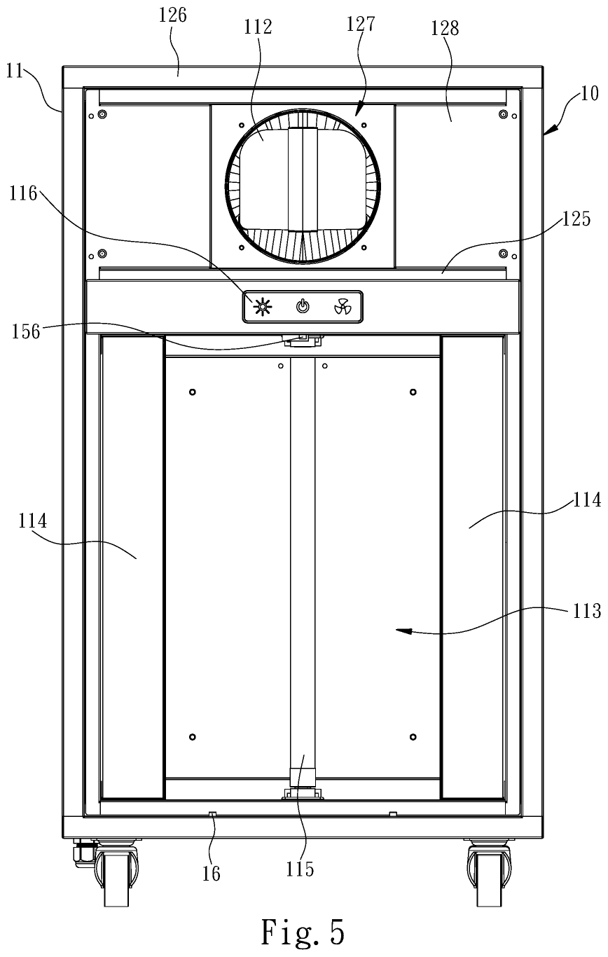

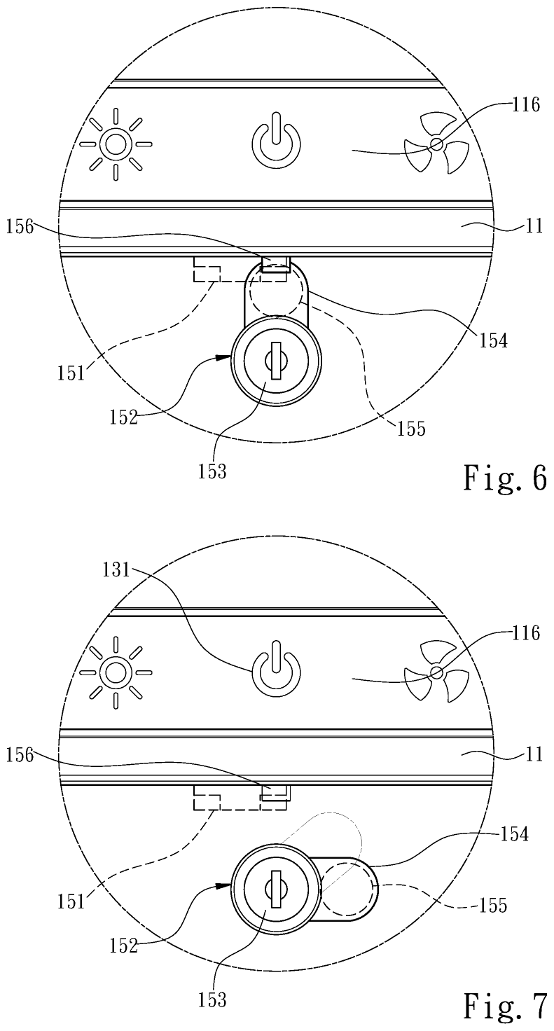

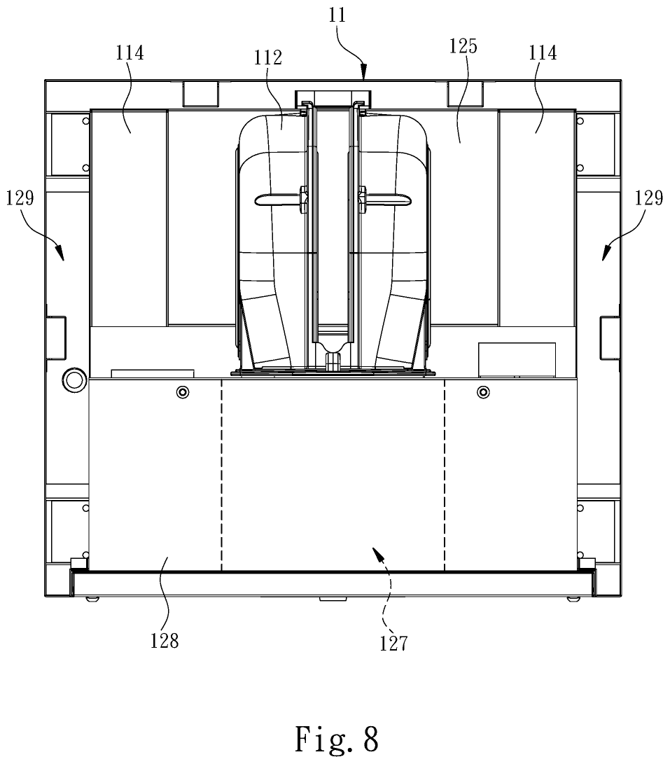

Referring to FIGS. 1, 2, 3, 4, 5, 6, 7, and 8, the invention provides an air purifier 100, comprising a body 10 and a control module 20. The body 10 is provided with a case 11, a case door 14 and a door lock 15. The case door 14 is arranged on the case 11 and provided with at least one air inlet 141. Whether the case door 14 is opened or closed relative to the case 11 is decided based on a state of the door lock 15. For example, when the door lock 15 is not operated, the door lock 15 fixes the case door 14 with the case 11 closes the case door 14 relative to the case 11; when the door lock 15 is operated, the case door 14 is opened relative to the case 11.

Also, the case 11 is provided with at least one air outlet 111, an air blower 112, a working chamber 113, at least one filter 114, at least one ultraviolet lamp 115 and at least one controller 116. The at least one air outlet 111 provides an air outlet function of the air purifier 100. The air blower 112 is located in the case 11, and an air outlet part of the air blower 112 faces the at least one air outlet 111. The air blower 112 extracts air and blows air toward the at least one air outlet 111 after being turned on. The working chamber 113 is located in the case 11. The working chamber 113 is closed when the case door 14 is not opened, and the working chamber 113 turns to be opened when the case door 14 is opened. The working chamber 113 communicates with the air inlet 141 and the air inlet part of the air blower 112, and the working chamber 113 allows external air to flow towards the air blower 112 after entering the working chamber 113. The filter 114 and the ultraviolet lamp 115 are arranged in the working chamber 113 and purify the air coming from the air inlet 141. In detail, the filter 114 provides an air filtering function and may be a high-efficiency particulate air (HEPA) filter. While the ultraviolet lamp 115 is turned on and generates ultraviolet light, sterilization of air is done by energy of the ultraviolet light. Also, the controller 116 is apparently provided on the surface of the case 11, and the controller 116 allows operation and generates a control signal 117 after being operated. In one embodiment, when the controller 116 is a touch panel, the touch panel is provided with a plurality of touch blocks. The plurality of touch blocks respectively corresponds to a power supply of the air purifier 100, the air blower 112 and the ultraviolet lamp 115. The touch panel generates the control signal 117 after being operated and enables the control module 20 to control correspondingly to the control signal 117, for example, controlling on-off of the power supply of the air purifier 100, operation speed of the air blower 112, on-off of the ultraviolet lamp 115 and the like. In another embodiment, when the controller 116 is a mechanical key, a plurality of controllers 116 are provided and respectively corresponds to the power supply of the air purifier 100, the air blower 112 and the ultraviolet lamp 115. The controllers 116 enable the control module 20 to control correspondingly after being operated, which will not be described here.

In addition, the door lock 15 comprises a magnetic reed switch 151 and a lock 152. The magnetic reed switch 151 undergoes a magnetic attraction to sense. The lock 152 is matched with the magnetic reed switch 151 and serves as an induced object in the magnetic attraction. Specifically, the lock 152 is provided with a lock cylinder 153, a lock tongue 154 and a magnet 155. The lock cylinder 153 is arranged on the case 11 and allows operation. The lock tongue 154 is connected with the lock cylinder 153. The lock tongue 154 is rotated relative to the magnetic reed switch 151 when the lock cylinder 153 is operated, the magnet 155 is arranged on the lock tongue 154 and moves along with the lock tongue 154, and the magnet 155 forms a magnetic attraction with the magnetic reed switch 151. Also, the lock 152 is provided with a first state and a second state when being implemented. The first state is that when the lock tongue 154 is being rotated to a specific angle relative to the lock cylinder 153, the lock tongue 154 drives the magnet 155 to displace, so as to enable the magnet 155 to break the magnetic attraction with the magnetic reed switch 151. The second state is that when the lock tongue 154 is rotated relative to the lock cylinder 153 without reaching the specific angle, and the magnet 155 is not out of a sensing range of the magnetic reed switch 151, so that the magnetic attraction between the magnet 155 and the magnetic reed switch 151 is not broke. In one embodiment, the specific angle is adjusted as 50 degrees. In this embodiment, when the lock tongue 154 is rotated 50 degrees, although the magnetic attraction between the magnetic reed switch 151 and the magnet 155 is broke, the case door 14 is still cannot be completely opened.

The control module 20 comprises a power supply unit 21 and a control unit 22. The power supply unit 21 is arranged in the case 11 and is connected with the air blower 112 and the ultraviolet lamp 115. The power supply unit 21 serves as a power supplier of the air blower 112 and the ultraviolet lamp 115, that is to say, the power supply unit 21 receives an external electricity and converts the external electricity to working electricity supplied for the air blower 112 and the ultraviolet lamp 115 to work. The control unit 22 is connected with the power supply unit 21 and the controller 116. The control unit 22 receives the control signal 117 transmitted from the controller 116 and decides works of the air blower 112 and the ultraviolet lamp 115 according to a content of the control signal 117. Further, the control unit 22 is connected with the magnetic reed switch 151. The control unit 22 is conducted with the magnetic reed switch 151 when the magnetic attraction between the magnetic reed switch 151 and the magnet 155 is formed. The control unit 22 is not conducted with the magnetic reed switch 151 when the magnetic attraction between the magnetic reed switch 151 and the magnet 155 is broke. Thus, the control unit 22 controls the air blower 112 and the ultraviolet lamp 115 based on that the lock 152 is in the first state or the second state. More specifically, when the lock 152 is in the first state, the control unit 22 enters a forced stop state; and when the lock 152 is in the second state, the control unit 22 enters a normal working state.

The following will describe implementation of the air purifier 100. Assuming that, in the beginning, the case door 14 is locked with the case 11, and the magnet 155 and the magnetic reed switch 151 are in the magnetic attraction. At this time, the lock 152 is in the second state, and then the control unit 22 enters the normal working state, that is to say, the control unit 22 unlocks the controller 116, so that the controller 116 is allowed to generate the control signal 117 through operation of a user. After this, the control unit 22 turns on the air blower 112 and the ultraviolet lamp 115 based on the control signal 117. Next, when opening the case door 14, the lock tongue 154 is rotated to reach the specific angle (for example, 50 degrees), and the case door 14 is still not operated to be completely opened relative to the case 11, the magnet 155 breaks the magnetic attraction with the magnetic reed switch 151, so that the lock 152 turns to enter the first state from the second state. At this time, as the control unit 22 is not connected with the magnetic reed switch 151, the control unit 22 will turn to the forced stop state from the normal working state and locks the controller 116 to disable the controller 116 to generate the control signal 117. Then the lock 152 is continuously rotated until the door lock 15 unrestricted position of the case door 14, the case door 14 is allowed to be completely opened relative to the case 11, and the magnet 155 remains breaking the magnetic attraction. Once the lock 152 is operated again and returns to the second state, the magnet 155 restores the magnetic attraction with the magnetic reed switch 151; while the control unit 22 then turns to the normal working state from the forced stop state, so that limitation to the controller 116 is released, so as to generate the control signal 117.

From the above, through arrangement of the magnetic reed switch 151 and the control unit 22, the invention enables the control unit 22 to forcibly stop the controller 116 before the case door 14 is completely opened, so that the controller 116 is disabled to generate the control signal 117. That is to say, the air purifier 100 of the invention prevents eyes of the user from being irradiated by the ultraviolet light and prevents from the situation that the user unintentionally operated the controller 116 when opening the case door 14 mistakenly turning on the ultraviolet lamp 115 and the air blower 112. Meanwhile, in the invention, the magnetic reed switch 151 is not arranged on the main power supply circuit, does not change the power supply of the air purifier 100, but is used for deciding whether the control unit 22 enters the forced stop state or the normal working state. By virtue of this, the invention omits designs for insulation while achieving safety and simplifying a circuit.

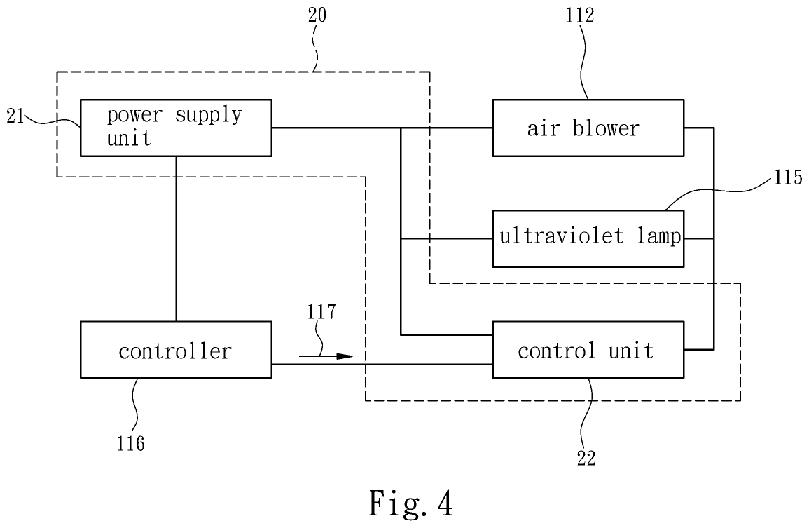

Moreover, referring to FIGS. 4, 5, 6, and 7, in one embodiment, when the controller 116 is the touch panel, the invention is convenient for the user to observe whether the controller 116 is locked; and when the control unit 22 enters the forced stop state, at least one of the touch blocks may generate different light indicators. For example, when the controller 116 is locked, one of the touch blocks corresponding to the power supply unit 21 (shown as reference number 131) serves as a power supply switch for controlling the air purifier 100 and a long lighting red light signal is indicated, thereby prompting the user. It should be understood that the foregoing examples are not used for limiting the display mode of the touch blocks. In practice, the display mode of the touch blocks may be designed according to the actual demands.

In addition, referring to FIGS. 1, 2, 3, 4, 5, 6, and 7, in one embodiment, the door lock 15 comprises a stopper 156. The stopper 156 is arranged on one side of the case 11 adjacent to the case door 14, and the stopper 156 is provided for the lock tongue 154 abutting thereto. When the stopper 156 contacts the lock tongue 154, the position of the lock tongue 154 is limited, and then the case door 14 is prevented from being opened relative to the case 11 by mistake. Further, the stopper 156 and the magnetic reed switch 151 are arranged at an interval. The stopper 156 and the magnetic reed switch 151 are located on two opposite faces of the lock tongue 154 respectively. A distance between the stopper 156 and the magnetic reed switch 151 is long enough for the lock tongue 154 and the magnet 155 to be arranged therebetween. In other words, the distance between the stopper 156 and the magnetic reed switch 151 is larger than or equal to total thicknesses of the lock tongue 154 and the magnet 155. Also, in the invention, the magnet 155 and the magnetic reed switch 151 generate stable magnetic attraction effect. The face of the lock tongue 154 provided with the magnet 155 faces the magnetic reed switch 151, while the face of the lock tongue 154 not provided with the magnet 155 faces the stopper 156.

Following the above, in one embodiment, to assist assembly of the case door 14 and the case 11 of the invention, the body 10 is provided with at least one convex column 16 arranged on the case 11 and at least one opening 17 formed in the case door 14 and matched with the convex column 16. When the case door 14 is assembled on the case 11, the at least one opening 17 is provided for the at least one convex column 16 being arranged therein. The case door 14 is being assisted to fix to an assembly position of the case 11.

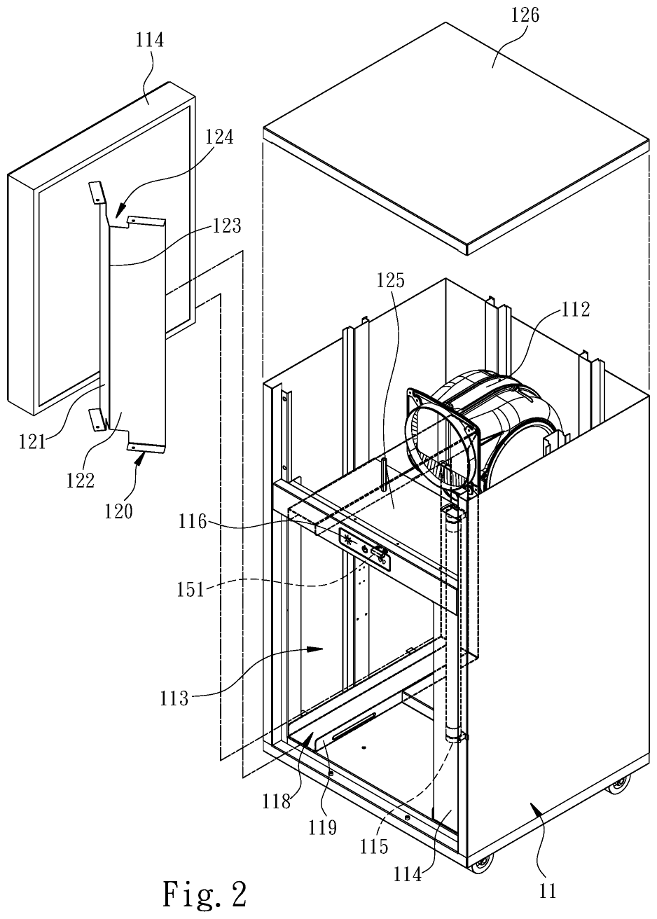

In another aspect, referring to FIGS. 2, 3, 4, and 5, in one embodiment, to restrict position of the filter 114 of the invention, the case 11 is provided with at least one positioning groove 118. The at least one positioning groove 118 is formed in the working chamber 113, and the filter 114 is arranged in the at least one positioning groove 118. When the filter 114 is arranged in the positioning groove 118, the at least one positioning groove 118 limits the position of the filter 114, and thus dislocation of the filter 114 is prevented. Further, the case 11 is internally provided with at least one positioning piece 119. In the invention, the positioning groove 118 is shaped according to the at least one positioning piece 119, and the at least one positioning piece 119 is arranged in the working chamber 113 and is matched with the filter 114. Also, to prevent the eyes of the user from being directly irradiated by the ultraviolet light, the case 11 of one embodiment of the invention is provided with at least one shielding plate 120 arranged in the working chamber 113. The at least one shielding plate 120 is located on one side of the ultraviolet lamp adjacent to the case door 14. The at least one shielding plate 120 is used for shielding the ultraviolet lamp 115, thereby reducing the risk that the user being disposed to the ultraviolet light. In detail, the shielding plate 120 is provided with a first plate 121 and a second plate 122. The second plate 122 is connected with the first plate 121, and the second plate 122 is bended relative to the first plate 121, that is to say, an included angle is formed between the second plate 122 and the first plate 121. Also, in the invention, the shielding plate 120 is in a bending shape. For convenience in assembly of the shielding plate 120, the shielding plate 120 is provided with a ridge line 123 and at least one hollowed area 124, the ridge line 123 arranged at a joint of the first plate 121 and the second plate 122. The ridge line 123 is located at a bending part of the shielding plate 120. The at least one hollowed area 124 is arranged on the ridge line 123.

Following the above, in one embodiment, the case 11 comprises a rack 125 and a housing 126. The rack 125 is provided for the air blower 112 to be arranged thereon. The housing 126 connects the rack 125 and the case door 14. Also, in the invention, the case 11 is internally provided with an air blowing chamber 127. The air blowing chamber 127 communicates with the air outlet part of the air blower 112 and the air outlet 111. The air blowing chamber 127 guides air coming from the air outlet part of the air blower 112 to flow toward the air outlet 111. Further, the air blowing chamber 127 is defined by an air blowing inner box 128 in the case 11. The air blowing inner box 128 is arranged on the rack 125 with the two ends connecting with the air blower 112 and the air outlet 111, respectively.

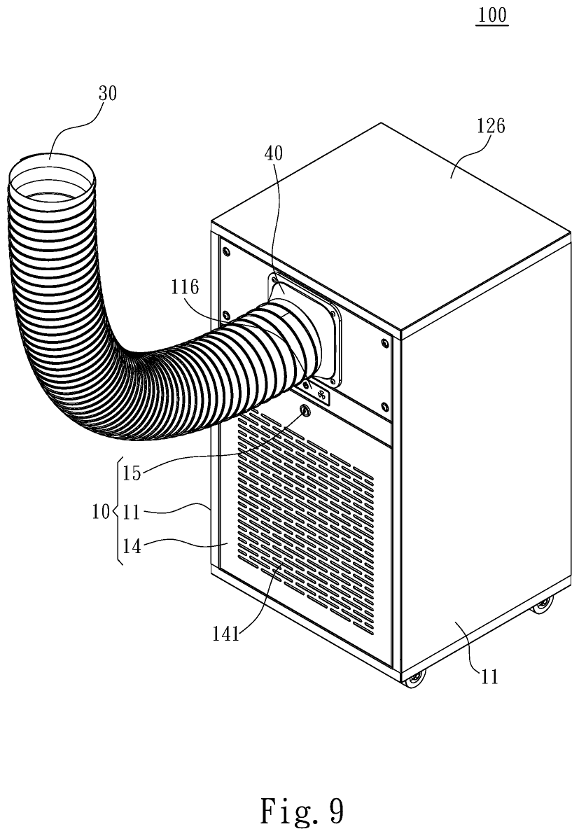

Further, in another embodiment, referring to FIGS. 1, 2, 3, 4, 5, 6, 7, 8, and 9, the air purifier 100 of the invention may be further provided with an external air exhaust pipe 30 externally connected to the case 11. The external air exhaust pipe 30 is detachable and may be disassembled relative to case 11 based on the use demand. The external air exhaust pipe 30 communicates with the air outlet 111 and receives air coming from the air outlet 111. Also, in the invention, to assist the external air exhaust pipe 30 to receive air coming from the air outlet 111, the air purifier 100 is provided with an engagement sleeve 40 sleeved on the external air exhaust pipe 30.

Two ends of the engagement sleeve 40 are engaged to the external air exhaust pipe 30 and the air outlet 111 respectively. The engagement sleeve 40 surrounds the periphery of the air outlet 111 and guides the air from the air outlet 111 to flow into the external air exhaust pipe 30.

Following the above, in another embodiment, referring to FIGS. 2, 3, 4, 5, 6, 7, and 8, the rack 125 and the housing 126 collectively define a bridging chamber 129. The bridging chamber 129 is located on one side of the filter 114 not facing the working chamber 113. The bridging chamber 129 is bridged to the air inlet part of the air blower 112 and the working chamber 113. The bridging chamber 129 receives an air coming from the filter 114 and enables the air to flow toward the air inlet part of the air blower 112 when the air blower 112 is turned-on.

In another aspect, in one embodiment, referring to FIGS. 2, 3, 4, 5, 6, 7, and 8, in the invention, the case 11 is further provided with a deodorizer 130. The deodorizer 130 is located in the working chamber 113 and is arranged on the case door 14. The deodorizer 130 adsorbs peculiar smell molecules in the air and provides a deodorization function.

What is claimed is:

1. An air purifier, comprising:
a body, comprising a case, a case door arranged on the case and provided with at least one air inlet, and a door lock, wherein the case is provided with at least one air outlet, an air blower provided with an air outlet part facing the at least one air outlet, a working chamber communicated with the at least one air inlet and an air inlet part of the air blower, at least one filter arranged in the working chamber, at least one ultraviolet lamp arranged at the working chamber, and at least one controller, the at least one controller is apparently provided on a surface of the case and generates a control signal after being operated, a state of the door lock decides whether the case door allows the working chamber to be switched open, wherein the door lock comprises a magnetic reed switch arranged at the case, and a lock matched with the magnetic reed switch, wherein the lock is provided with a lock cylinder on the case door, a lock tongue connected with the lock cylinder and being rotated relative to the magnetic reed switch, and a magnet arranged on the lock tongue and forming a magnetic attraction with the magnetic reed switch, the lock is provided with a first state and a second state, when the lock is in the first state and the lock tongue is rotated relative to the lock cylinder to a specific angle, the magnet breaks the magnetic attraction with the magnetic reed switch, and when the lock is in the second state, the magnetic attraction between the magnet and the magnetic reed switch is not broke; and
a control module, comprising a power supply unit and a control unit, the power supply unit arranged at the case and connected with the air blower and the ultraviolet lamp, the control unit connected with the power supply unit, the control unit deciding works of the air blower and the ultraviolet lamp based on the control signal, the control unit being provided with a forced stop state of locking the controller to disable the controller to generate the control signal when the lock enters the first state, and the control unit being provided with a normal working state of the controller unlocked when the lock is in the second state.

2. The air purifier according to claim 1, wherein the specific angle is 50 degrees.

3. The air purifier according to claim 1, wherein the door lock comprises a stopper arranged on one side of the case adjacent to the case door, and the stopper provided for the lock tongue abutting thereto.

4. The air purifier according to claim 3, wherein the stopper and the magnetic reed switch are located on two opposite sides of the lock tongue respectively.

5. The air purifier according to claim 1, wherein the case comprises a deodorizer arranged in the working chamber.

6. The air purifier according to claim 5, wherein the case comprises a rack and a housing, the rack is provided for the air blower to be arranged thereon, and the housing connects the rack and the case door.

7. The air purifier according to claim 6, wherein the case comprises an air blowing chamber communicated with the air outlet part of the air blower and the air outlet.

8. The air purifier according to claim 7, wherein the case is internally provided with an air blowing inner box arranged on the rack and defining the air blowing chamber.

9. The air purifier according to claim 8, wherein the rack and the housing collectively define a bridging chamber bridging the air inlet part of the air blower and the working chamber.

10. The air purifier according to claim 1, wherein the air purifier comprises an external air exhaust pipe externally connected to the case and communicated with the air outlet.

11. The air purifier according to claim 10, wherein the air purifier comprises an engagement sleeve sleeved on the external air exhaust pipe and engaging to the air outlet.

12. The air purifier according to claim 1, wherein the case comprises at least one positioning groove, the at least one positioning groove is formed in the working chamber, and the filter is arranged in the at least one positioning groove.

13. The air purifier according to claim 12, wherein the case comprises at least one positioning piece arranged in the working chamber, and the at least one positioning piece is shaped into the at least one positioning groove.

14. The air purifier according to claim 13, wherein the case comprises at least one shielding plate arranged in the working chamber and located on one side of the ultraviolet lamp adjacent to the case door.

15. The air purifier according to claim 14, wherein the at least one shielding plate comprises a first plate and a second plate connected with the first plate, and an included angle is formed between the first plate and the second plate.

16. The air purifier according to claim 15, wherein the shielding plate comprises a ridge line arranged at a joint of the first plate and the second plate, and at least one hollowed area arranged on the ridge line.

17. The air purifier according to claim 16, wherein the body comprises at least one convex column arranged on the case, and at least one opening formed in the case door and matched with the convex column.
